(19) United States
(12) Patent Application Publication
(10) Pub. No.: US 2019/0286151 A1
(43) Pub. Date: Sep. 19, 2019

(54) AUTOMATED DRIVING SYSTEMS AND CONTROL LOGIC FOR CLOUD-BASED SCENARIO PLANNING OF AUTONOMOUS VEHICLES

(71) Applicant: GM Global Technology Operations LLC, Detroit, MI (US)

(72) Inventors: Praveen Palanisamy, Sterling Heights, MI (US); Sayyed Rouhollah Jafari Tafti, Troy, MI (US); Soheil Samii, Royal Oak, MI (US); Marcus J. Huber, Saline, MI (US)

(73) Assignee: GM Global Technology Operations LLC, Detroit, MI (US)

(21) Appl. No.: 15/920,810

(22) Filed: Mar. 14, 2018

(51) Int. Cl. G05D 1/02; G05D 1/00

(52) U.S. Cl. CPC G05D 1/0217; H04L 67/12; G05D 1/0088

(57) ABSTRACT

Presented are scenario-planning and route-generating distributed computing systems, methods for operating/constructing such systems, and vehicles with scenario-plan selection and real-time trajectory planning capabilities. A method for controlling operation of a motor vehicle includes determining vehicle state data, such as a current position and velocity of the vehicle, and path plan data, such as an origin and desired destination of the vehicle. A remote computing node off-board from the motor vehicle generates a list of trajectory plan candidates based on the vehicle state data, the path plan data, and current road scenario data. The remote computing node then calculates a respective travel cost for each candidate in the trajectory plan candidates list, and sorts the list from lowest to highest travel cost. The candidate with the lowest travel cost is transmitted to a resident vehicle controller. The vehicle controller executes an automated driving operation based on the received trajectory plan candidate.

### INTRODUCTION

The present disclosure relates generally to motor vehicles with automated driving capabilities. More specifically, aspects of this disclosure relate to route generation and scenario planning for autonomous vehicles.

Current production motor vehicles, such as the modern-day automobile, are originally equipped or retrofit with a network of onboard electronic devices that provide automated driving capabilities that help to minimize driver effort. In automotive applications, for example, the most recognizable type of automated driving feature is the cruise control system, which allows a vehicle operator to set a particular vehicle speed and have the onboard vehicle computer system maintain that speed without the driver operating the accelerator or brake pedals. Next-generation Adaptive Cruise Control (ACC; also designated Autonomous Cruise Control) is a computer-automated vehicle control feature that regulates vehicle speed while concomitantly managing fore and aft spacing between the host vehicle and leading or trailing vehicles. Another type of automated driving feature is the Collision Avoidance System (CAS), which detects imminent collision conditions and provides a warning to the driver while also taking action autonomously—e.g., by steering or braking—without driver input. Intelligent Parking Assist Systems (IPAS), Lane Monitoring Systems, and other autonomous car-maneuvering features are also available on many modern-day automobiles.

As vehicle sensing, communication, and control systems continue to improve, manufacturers will persist in offering more autonomous driving capabilities with the aspiration of eventually offering fully autonomous vehicles competent to operate among heterogeneous vehicle types in both urban and rural scenarios. Original equipment manufacturers (OEM) are moving towards interconnected “talking” cars with higher-level driving automation that employ autonomous systems for vehicle routing, lane changing, passing, scenario planning, etc. Automated route generation systems utilize vehicle state and dynamics sensors, neighboring vehicle and road condition data, and path prediction algorithms to provide path generation with automated lane center and lane change forecasting. Computer-assisted rerouting techniques offer a recommended travel path for the vehicle with predicted alternative travel routes that may be updated, for example, based on real-time and estimated vehicle data.

### SUMMARY

Disclosed herein are scenario-planning and route-generating distributed computing systems and attendant control logic for autonomous vehicles, methods for operating and methods for constructing such systems, and motor vehicles with scenario-plan selection and real-time trajectory planner capabilities. By way of example, there is presented a scenario planning system that opportunistically utilizes cloud-based services to provide a comprehensive list of trajectory plan candidates under dynamic road scenarios. The cloud component utilizes high-performance computing to generate optimized scenario plans and trajectory candidates, which are transmitted via wireless media to an in-vehicle scenario planning module. The host vehicle's scenario planning module assesses locally sensed dynamic road scenario information to select, in real-time, a best candidate and provide other feasible globally optimal trajectory candidates. This best candidate is sent to an onboard trajectory planner module for final refinement and execution by the vehicle's central processing unit. Prior to execution, the trajectory planner module may first determine, in real-time, if the “best” candidate is in fact an “optimal” candidate, e.g., via estimating whether or not the best candidate is a collision free option and/or is kinodynamically feasible.

By off-boarding trajectory plan generation to a remote node, disclosed features help to reduce in-vehicle embedded computing capacity requirements for scenario planning, which may be considered a key function for autonomous driving. An associated advantage of reduced onboard computing requirements is an increase in vehicle battery life and, thus, improved range for hybrid and battery electric vehicles. Another attendant benefit may include a unified source of feasible trajectory plan candidates and lane-level road boundary information, thus enabling shared cloud computing and consolidation of computation across a fleet of vehicles. Disclosed scenario planning features opportunistically utilize cloud-based services to provide more efficient, simplified, and comprehensive navigation plans for in-vehicle trajectory generation under dynamic road scenarios. This may offer a longer planning horizon beyond line-of-sight of sensors, while providing a unified source of feasible trajectory plan candidates and lane-level road boundary information. Disclosed features may also offer custom resolution of cloud-generated data based on individual vehicle connectivity bandwidth and latency.

Aspects of this disclosure are directed to cloud-based scenario planning and route generating logic and computer-executable algorithms for autonomous vehicles. For instance, a method is presented for controlling an automated driving operation of a motor vehicle. This representative method includes, in any order and in any combination with any of the disclosed features and options: determining vehicle state data, which may include a current position, velocity, acceleration, heading, etc., of the motor vehicle, and path plan data, which may include an origin and desired destination of the motor vehicle; generating, via a remote computing node off-board from the motor vehicle (e.g., a backend cloud server computer), a list of trajectory plan candidates based on the vehicle state data, the path plan data, and current road scenario data, which may include real-time situational/contextual data of the vehicle; calculating, via the remote computing node, a respective travel cost for each trajectory plan candidate in the list of trajectory plan candidates; sorting, via the remote computing node, the list of trajectory plan candidates from a lowest respective travel cost to a highest respective travel cost; transmitting, from the remote computing node to a resident vehicle controller onboard the motor vehicle, the sorted list of trajectory plan candidates; identify, via the resident vehicle controller, the trajectory plan candidate with the lowest respective travel cost; and executing, via the resident vehicle controller, an automated driving operation based on the transmitted trajectory plan candidate.

Any of the disclosed systems, methods and devices may optionally include estimating, via a scenario processor of the remote computing node, a scenario plan for the origin and desired destination of the motor vehicle. This scenario plan may include lane centering estimation, lane changing estimation, vehicle passing estimation, and/or object avoidance estimation. Estimating the scenario plan may include determining appropriate steps to manage or otherwise “handle” expected traffic signs, intersections, road conditions, vehicle maneuvers, connections and/or traffic conditions. The remote computing node's scenario processor may track the vehicle while on route to assist with each handling determination. The estimated scenario plan may then be used to generate the trajectory plan candidates list. Moreover, a reference path generator of the remote computing node may cache high-resolution, multi-lane boundary and maneuver information for a planned route in a remote memory device. The cached information may then be used to help generate the trajectory plan candidates list.

Any of the disclosed systems, methods and devices may optionally include the reference path generator of the remote computing node transmitting the travel costs for the sorted list of trajectory plan candidates to the scenario selector module. The scenario selector module of the resident vehicle controller will then determine dynamic vehicle data, such as locally sensed object data and behavioral preference data of the motor vehicle, and then update the respective travel costs for the trajectory plan candidates based on this dynamic vehicle data. Using the updated travel costs, the scenario selector module may then re-sort the trajectory plan candidates list from an updated highest respective travel cost to an updated lowest respective travel cost.

Additional options may include the scenario selector module transmitting an updated trajectory plan candidate with the updated lowest respective travel cost to the real-time trajectory planner module. The trajectory planner module may then determine if this candidate is an optimal candidate, e.g., estimate if the updated trajectory plan candidate will be collision free and kinodynamically feasible. If the updated trajectory plan candidate is not an optimal candidate, the real-time trajectory planner module may transmit a request to the scenario selector module for another trajectory plan candidate, e.g., the one with the second lowest respective travel cost. The real-time trajectory planner module may define a final trajectory by refining the updated trajectory plan candidate that is the optimal candidate. In this instance, the automated driving operation is executed based on the updated, optimal and finalized trajectory plan candidate.

Any of the disclosed systems, methods and devices may optionally include the scenario processor of the remote computing node conducting state estimation, which may comprise obtaining locally fused lane information and obtaining semantic road scenario data. The reference path generator of the remote computing node may contemporaneously identify one or more alternative “recovery” plans. The scenario processor of the remote computing node may receive dynamic vehicle data, such as locally sensed object data and behavioral preference data of the motor vehicle, and maplet data, such as geographic information for the origin and desired destination of the motor vehicle. Maplet and dynamic vehicle data may be used to generate the list of trajectory plan candidates.

Other aspects of the present disclosure are directed to distributed vehicle control systems and cloud-based scenario planning architectures for regulating operation of autonomous motor vehicles. As used herein, the term “motor vehicle” may include any relevant vehicle platform, such as passenger vehicles (internal combustion engine, hybrid, full electric, fuel cell, etc.), commercial vehicles, industrial vehicles, tracked vehicles, off-road and all-terrain vehicles (ATV), farm equipment, boats, airplanes, etc. In addition, the term “autonomous vehicle” may include any relevant vehicle platform that may be classified as a Society of Automotive Engineers (SAE) Level 2, 3, 4 or 5 vehicle. SAE Level 0, for example, is generally typified as “unassisted” driving that allows for vehicle-generated warnings with momentary intervention, but otherwise relies solely on human control. By comparison, SAE Level 3 allows for unassisted, partially assisted, and fully assisted driving with sufficient vehicle automation for full vehicle control (steering, speed, acceleration/deceleration, etc.), while obliging driver intervention within a calibrated timeframe. At the upper end of the spectrum is Level 5 automation that altogether eliminates human intervention (e.g., no steering wheel, gas pedal, or shift knob).

In an example, an autonomous vehicle control system is presented that includes one or more motor vehicles that wirelessly communicate with a remote (cloud-based) computing node, which is physically off-board and displaced from the motor vehicle(s). Each motor vehicle may include a vehicle body with any desired powertrain, and a resident vehicle controller that is mounted to the vehicle body. The resident vehicle controller includes a scenario selector module and a real-time trajectory planner module, whereas the remote computing node includes a scenario processor and a reference path generator processor (“processor” and “module” used interchangeably herein). During system operation, the scenario processor determines vehicle state data and path plan data for the motor vehicle. The vehicle state data may include a current position and velocity of the motor vehicle, whereas the path plan data may include an origin and desired destination of the motor vehicle. The reference path generator processor generates a list of trajectory plan candidates based on the vehicle state data, the path plan data, and current road scenario data (e.g., real-time contextual data of the motor vehicle).

Continuing with the above example, the reference path generator then calculates a respective travel cost for each candidate in the trajectory plan candidates list, sorts the list of trajectory plan candidates from a lowest to a highest respective travel cost, and transmits the sorted list to the resident vehicle controller of the motor vehicle. The scenario selector module determines from the sorted list an optimal trajectory plan candidate, e.g., the candidate with the lowest respective travel cost. In response to the received trajectory plan candidate being an optimal and refined candidate, the real-time trajectory planner executes an automated driving operation based on the plan candidate.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative motor vehicle with a network of in-vehicle controllers, sensors and communication devices for executing autonomous driving operations in accordance with aspects of the present disclosure.

FIG. 2 is a diagrammatic illustration of a distributing computing architecture for a representative scenario planning system in accordance with aspects of the present disclosure.

FIG. 3 is a workflow diagram illustrating the operational layout and exchanges for the scenario planning system of FIG. 2.

FIG. 4 is a flowchart for a scenario planning and route generating protocol that may correspond to instructions executed by onboard and remote control-logic circuitry, programmable electronic control unit, or other computer-based device or network of devices in accord with aspects of the disclosed concepts.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. There are shown in the drawings and will herein be described in detail representative embodiments of the disclosure with the understanding that these illustrated examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including” and “comprising” and “having” shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a normal driving surface, for example.

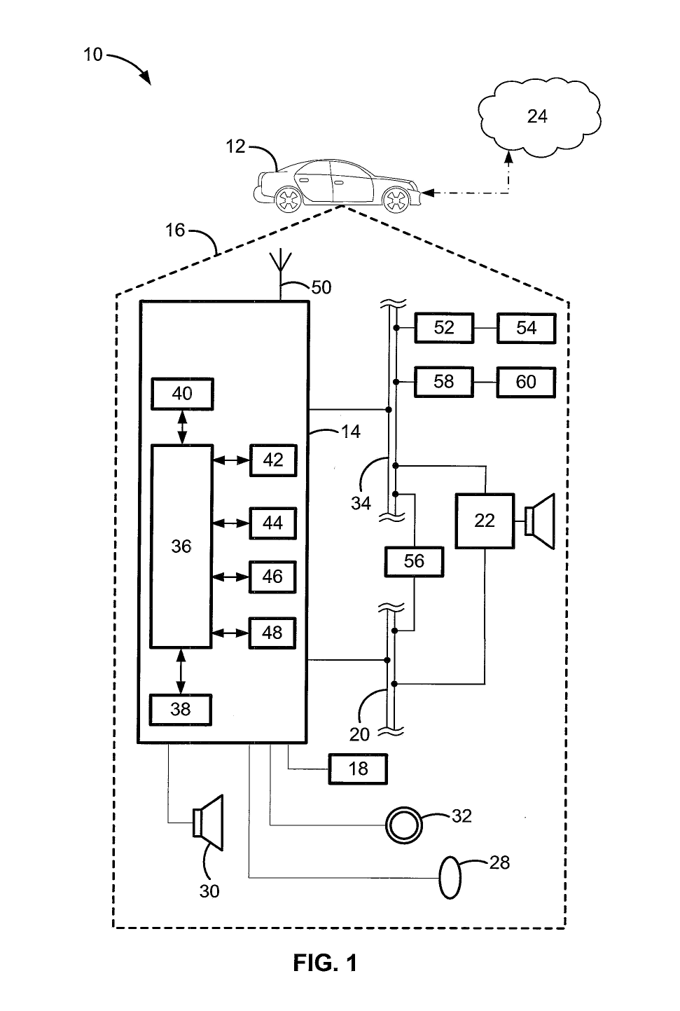

Referring now to the drawings, wherein like reference numbers refer to like features throughout the several views, there is shown in FIG. 1 a representative automobile, which is designated generally at 10 and portrayed herein for purposes of discussion as a sedan-style autonomous passenger vehicle. Packaged within a vehicle body 12 of the automobile 10, e.g., distributed throughout the different vehicle compartments, is an onboard network of electronic devices, such as the assorted computing devices and control units described below. The illustrated automobile 10—also referred to herein as “motor vehicle” or “vehicle” for short—is merely an exemplary application with which aspects and features of this disclosure may be practiced. In the same vein, implementation of the present concepts for the specific architecture illustrated in FIG. 1 should also be appreciated as an exemplary application of the concepts and features disclosed herein. As such, it will be understood that aspects and features of this disclosure may be applied to any number and type and arrangement of networked controllers and devices, and implemented for any logically relevant type of motor vehicle. Moreover, only select components of the vehicle 10 have been shown and will be described in additional detail herein. Nevertheless, the motor vehicles and network architectures discussed herein may include numerous additional and alternative features, and other available peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (colloquially referred to as “telematics”) unit 14 that wirelessly communicates (e.g., via cell towers, base stations and/or mobile switching centers (MSCs), etc.) with a remotely located or “off-board” cloud computing system 24. Some of the other vehicle hardware components 16 shown generally in FIG. 1 include, as non-limiting examples, a display device 18, a microphone 28, a speaker 30, and input controls 32 (e.g., buttons, knobs, switches, keyboards, touchscreens, etc.). Generally, these hardware components 16 enable a user to communicate with the telematics unit 14 and other systems and system components within the vehicle 10. Microphone 28 provides a vehicle occupant with means to input verbal or other auditory commands; the vehicle 10 may be equipped with an embedded voice processing unit utilizing human/machine interface (HMI) technology. Conversely, speaker 30 provides audible output to a vehicle occupant and may be either a stand-alone speaker dedicated for use with the telematics unit 14 or may be part of a vehicle audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a local area network (LAN) interface, a controller area network (CAN), a media oriented system transfer (MOST), a local interconnection network (LIN) interface, and the like. Other appropriate communication interfaces may include those that conform with ISO, SAE, and IEEE standards and specifications. The network connection interface 34 enables the vehicle hardware 16 to send and receive signals with each other and with various systems and subsystems both outside or “remote” from the vehicle body 12 and within or “resident” to the vehicle body 12. This allows the vehicle 10 to perform various vehicle functions, such as controlling vehicle steering, governing operation of the vehicle's transmission, controlling engine throttle, engaging/disengaging the brake system, and other automated driving functions. For instance, telematics unit 14 receives and/or transmits data to/from a safety system ECU 52, an engine control module (ECM) 54, an infotainment application module 56, sensor interface module(s) 58, and assorted other vehicle ECUs 60, such as a transmission control module (TCM), a climate control module (CCM), a brake system module (BCM), etc.

With continuing reference to FIG. 1, telematics unit 14 is an onboard computing device that provides a mixture of services, both individually and through its communication with other networked devices. This telematics unit 14 is generally composed of one or more processors, which may be embodied as a discrete microprocessor, an application specific integrated circuit (ASIC), a central processing unit (CPU) 36, etc., operatively coupled to one or more electronic memory devices 38, each of which may take on the form of a CD-ROM, magnetic disk, IC device, semiconductor memory (e.g., various types of RAM or ROM), etc., and a real-time clock (RTC) 46. Communication capabilities with remote, off-board networked devices is provided via one or more or all of a cellular chipset/component 40, a wireless modem 42, a navigation and location chipset/component 44 (e.g., global positioning system (GPS)), a short-range wireless communication device 48 (e.g., a Bluetooth® unit or near field communications (NFC) transceiver), and/or a dual antenna 50. It should be understood that the telematics unit 14 may be implemented without one or more of the above listed components, or may include additional components and functionality as desired for a particular end use.

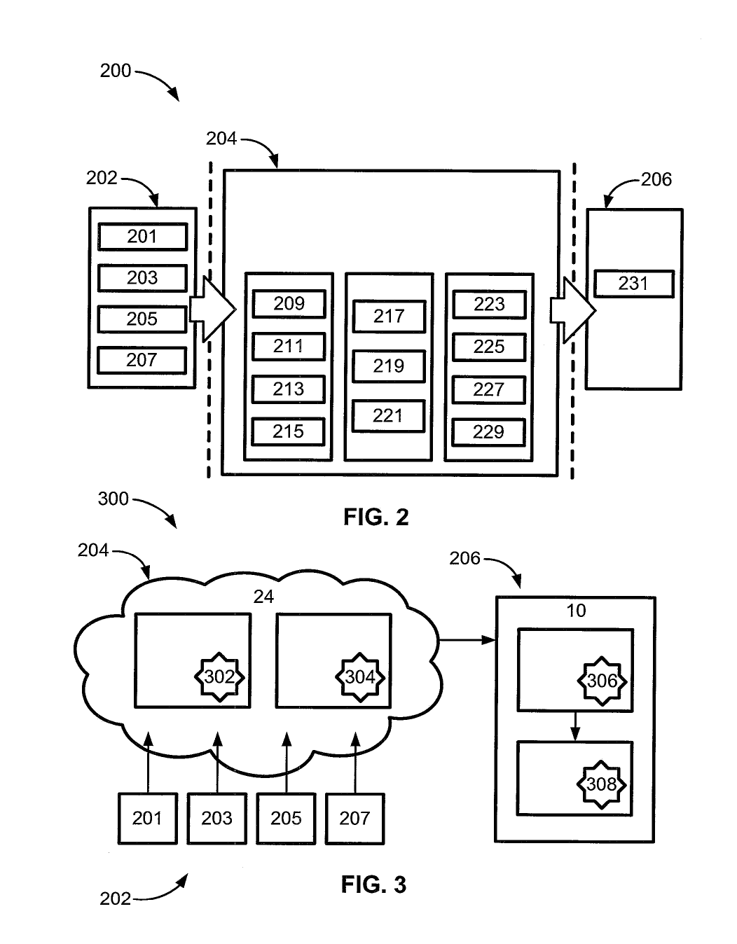

To assist the autonomous vehicle 10 of FIG. 1 with navigating both simple and complex driving scenarios, including passing stopped and moving vehicles, reacting properly to static and dynamic objects in the roadway, interacting appropriately at intersections, maneuvering in parking lots, and the like, a scenario planning system 200 provides opportunistic and efficient utilization of cloud-based and/or other remote computing services that offer massive computing capabilities and resources for autonomous vehicle planning computations. The scenario planning system 200 of FIG. 2 may govern use of such cloud/remote computing services based on vehicle-calibrated opportunity costs. Scenario planning system 200, for example, brokers the type, amount and/or resolution of planned data and trajectory candidates fetched from the remote computing services depending on the extent of available wireless communications bandwidth and network channel latency for a given timeframe. In so doing, the scenario planning system 200 is able to optimize and efficiently utilize off-board computation resources for planning processes related to autonomous driving under various connectivity and communication constraints that may exist for autonomous vehicle applications.

The representative scenario planning system 200 of FIG. 2 is generally composed of three interoperable, communicatively connected segments: an input provider segment 202, a scenario data segment 204, and an output consumer segment 206. On the input side of the scenario planning system 200, the input provider segment 202—which may be embodied as a backend server computer in combination with an in-vehicle electronic control unit (e.g., telematics unit 14 of FIG. 1)—helps to generate, retrieve, calculate and/or store (collectively designated “determine”) various types of input data, including host vehicle (HV) state data 201, dynamic information 203, maplet data 205, and path plan data 207. HV state data 201 may generally comprise the vehicle's 10 current position, heading, velocity, and/or acceleration information. Other types of vehicle state information may include real-time sensor-based yaw, pitch and roll data, lateral speed, lateral offset, and heading angle. Maplet data 205, on the other hand, may include any suitable navigation information for executing a desired driving operation, including road layout data, geographic data, infrastructure data, and topology data. Other maplet information may comprise stop sign and stop light data, speed limit data, planned road work and road closure data, etc. In addition, the path plan data 207 includes a present or expected starting point (origin) and a desired ending point (destination) for the vehicle 10.

Dynamic information 203 of FIG. 2 may generally encapsulate behavioral preferences and locally sensed object information. Examples of behavioral preferences may include desired practices particular to a given autonomous vehicle (AV). For instance, an occupant of the automobile 10 of FIG. 1 may prefer the AV prioritize passenger comfort over travel time. The scenario planning system 200 may respond to this behavioral preference by prioritizing routes that reduce the number of lane changes and avoid unpaved or unrepaired roads to reach a given destination, even if the overall time-to-destination or distance-to-destination is more than other alternatives routes. Locally sensed object information, on the other hand, includes information about static and dynamic objects external to the automobile 10 and sensed by one or more sensors mounted locally on the vehicle body 12. Cloud computing system 24 may aggregate or otherwise access crowd-sourced “globally sensed” object information, which is a collective of information gathered by several vehicles that share data with the cloud computing system 24.

With continuing reference to FIG. 2, the scenario data segment 204—which may be embodied as a remote computing node (e.g., cloud computing system 24 of FIG. 1)—receives as input data any or all of the information discussed above with respect to the input provider segment 202. Prior to, contemporaneous with, or after said data is received, scenario data segment 204 determines various additional categories of information for scenario planning, including reference trajectory data 209, left boundary data 211, lane center data 213, and right boundary data 215. Reference trajectory data 209 may include an immediate path information (e.g., trajectory, acceleration, speed, etc.) and immediate scenario information (traffic, pedestrians, etc.) of the autonomous vehicle 10 for a near-term timeframe, e.g., for the next 10-30 seconds. Left boundary data 211, lane center data 213, and right boundary data 215 may each provide corresponding road geometry data, such as estimated or detected or memory-stored left margin values, midpoint values, and right margin values, respectively, that correspond to the reference trajectory 209 of the autonomous vehicle 10. Additional road characteristics data provisioned at 209, 211, 213 and/or 215 may include a total number of lanes, a type or types of lanes (e.g., highway, service, residential, etc.), a lane width, a number or severity of curves in a road segment, etc.

To provide a comprehensive list of trajectory plan candidates under dynamic road scenarios, the scenario data segment 204 of FIG. 2 may also generate current road scenario data 217 and next scenario data 219. Current road scenario data 217 may include real-time information that is indicative of the present situational/contextual data of the vehicle 10, whereas next scenario data 219 may include data that is indicative of the near-term situational/contextual data of the vehicle 10, e.g., for the next 10-30 seconds. Lane usage data 221 may also be determined to estimate the population density of a current, near-term and/or future roadway of a potential trajectory candidate. As a non-limiting example, lane usage data 221 may include information about a predicted utilization of a lane, which may vary depending on a number of vehicles in the lane, the type or types of vehicles in a lane (e.g., ambulance, firetruck or police vehicles versus standard passenger vehicles versus bicycles and other pedestrian vehicles), and the resultant or anticipated traffic/average-speed on that lane. Other aggregated data may comprise: traffic congestion and related conditions 223, ambient temperature and related weather conditions 225, visibility level and related range-of-sight conditions 227, and/or light level and related daytime/nighttime conditions 229. Using any combination of data described above, the scenario data segment 204 generates and transmits a comprehensive list of trajectory plan candidates to a local trajectory planner 231 of the output consumer segment 206, which may be embodied as the autonomous passenger vehicle 10 of FIG. 1.

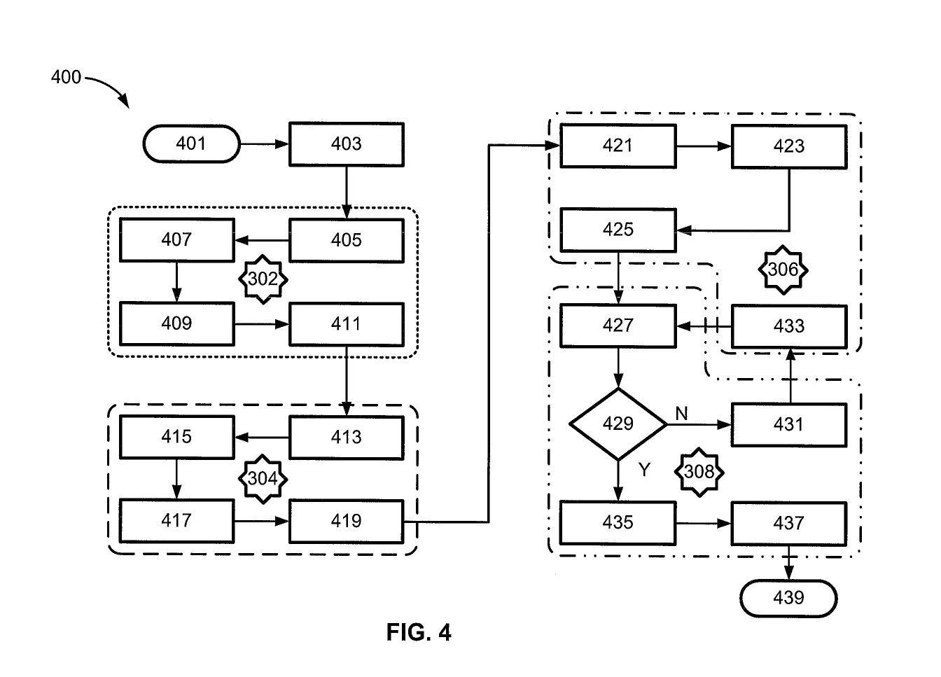

FIG. 3 presents a workflow diagram 300 that illustrates the operational layout and data exchanges for the scenario planning system 200 of FIG. 2. As indicated above, the scenario planning system 200 may be typified by an input provider segment 202 that helps to collect or create input data that may be required for route generation and scenario planning, a scenario data segment 204 that receives, aggregates and processes various inputs to generate lists of trajectory plan candidates, and an output consumer segment 206 that utilizes a trajectory plan candidates list to identify, vet, and execute an optimal trajectory candidate. In FIG. 3, the scenario data segment 204 is portrayed as a remote cloud computing system 24 that is generally composed of a scenario processor 302 that exchanges data with a reference path generator processor 304. Likewise, the output consumer segment 206 is illustrated as an autonomous vehicle 10 with a scenario plan selector module 306 that exchanges data with the scenario data segment 204 and a real-time trajectory planner module 308. Control module, module, controller, electronic control unit, processor, and permutations thereof may be defined to include any one or various combinations of one or more logic circuits, Application Specific Integrated Circuits (ASIC), electronic circuits, central processing units (e.g., microprocessor(s)), and associated memory and storage (e.g., read only, programmable read only, random access, hard drive, tangible, etc.)), whether resident, remote or a combination of both, executing one or more software or firmware programs or routines, combinational logic circuit(s), input/output circuit(s) and devices, appropriate signal conditioning and buffer circuitry, and other components to provide the described functionality.

With continuing reference to FIG. 3, the scenario processor 302 coordinates with the input provider segment 202 to accumulate the HV state data 201, which is discussed above with reference to FIG. 2. This operation may involve obtaining an initial position, heading, velocity, and/or acceleration (collectively “pose data”) from the vehicle 10, and determining a fused position estimate that approximates a localized position and heading of the vehicle 10 based on sensor-fused data from various sensor modalities (e.g., GPS, Wheel Encoder, Lidar, Map, etc.). A current HV state of the autonomous vehicle 10 may then be determined from the initial pose data and fused position estimate data; current HV state may be updated and stored in local memory.

Using HV state in conjunction with the maplet data 205 and pre-computed current plan information (that may be cached as a memory block to SRAM cache memory for fast-read operations), the scenario processor 302 may track the host vehicle 10 while on route between a designated origin and a designated destination. Cloud computing system 24 may implement this process, using map data, a global plan, and the vehicle's current state, to pre-compute information that may be required for further scenario planning, e.g., by exploiting the understanding that road networks are characteristically stationary and pre-mapped for ease of reference. A global plan (or “mission plan”) may include information about the autonomous vehicle's 10 start/origin, destination/goal, and higher-level plan information to reach a desired destination/goal. The pre-computed and cached information may be employed to find a current segment (e.g., a current stretch of roadway or lane that the vehicle 10 is currently on) and various needed connections and connection lengths.

Scenario processor 302 may thereafter execute a scenario plan estimation process, which may include “scenario handling” to determine the appropriate steps for managing expected traffic signs, connections, intersections, expected or unexpected road conditions, vehicle maneuvers, and/or expected or unexpected traffic conditions. As used herein, the term “handling” may be defined to include a protocol or technique to determine one or more appropriate steps to be added to a plan to manage various expected tasks (e.g., stopping at stop signs or stop lights, timing and execution of expected connections, timing and execution of advanced maneuvers, etc.). Search space estimation may then be conducted by the scenario processor 302 to obtain locally fused lane information and to obtain semantic road scenario information. Semantic road scenario info may include semantic information specific to a current scenario of the autonomous vehicle 10 (e.g., and stored in a machine-readable format).

Once the scenario processor 302 executes one or more or all of the processes described above, the reference path generator processor 304 utilizes the resultant information to generate and transmit scenario data candidates and respective rankings data to the scenario plan selector module 306 resident to the vehicle 10. In order to generate the candidates with associated rankings data, reference path generator 304 caches high-resolution, multi-lane boundary and maneuver information for the planned route, and concomitantly generates one or more alternative “recovery” plans, e.g., for scenarios where the vehicle 10 deviates from a given route or a given route unexpectedly becomes unavailable. After producing the trajectory plan candidates, the reference path generator processor 304 may calculate a navigation plan cost map by identifying an estimated cost for the vehicle 10 to navigate according to each trajectory plan candidate. The associated “cost” may comprise a combination of several factors, including but not limited to total energy expenditure for a given candidate, overall ride smoothness for a given candidate, total time required to complete a given candidate, expected maximum acceleration and/or deceleration, expected jerk, time delays, etc. The plans may then be ranked based on calculated cost, with a higher cost being associated with a lower rank.

The scenario plan selector module 306, which is resident to the vehicle 10 of output consumer segment 206, wirelessly communicates with the scenario data segment 204 of the scenario planning system 200 to retrieve the trajectory plan candidates and associated rankings data from the reference path generator processor 304. Using this information, along with available locally sensed data (e.g., local objects, lane data, and other local inputs), scenario plan selector module 306 is operable to update the navigation plan cost map, re-rank the candidates for the current scenario (if the need arises), and send an optimal candidate or subset of optimal candidates along with scenario data to the trajectory planner module 308. Local scenario plan selector module 306, after receiving the trajectory plan candidates from the remote cloud computing service 24, may gather new information from onboard vehicle sensors and local vehicle control modules; this information may be used to update the reference plans, their costs, and rankings.

For each optimal plan candidate received from the scenario plan selector module 306, the real-time trajectory planner module 308 checks the practicability of the candidate, e.g., by assessing whether or not the candidate is likely to be collision free and whether or not the candidate is likely to be kinodynamically feasible, etc. A trajectory plan may be designated as kinodynamically feasible if the vehicle's 10 kinematics and dynamics will allow it to follow the prescribed trajectory plan without stressing or exceeding the feasible operating space of the vehicles powertrain, braking, and steering systems. For instance, vehicle velocity, acceleration/deceleration, and occupant-experienced forces for a given candidate should satisfy corresponding vehicle-calibrated boundaries, while also meeting all kinematic vehicle constraints, such as avoiding obstacles while steering through traffic. If deemed practical, trajectory planner module 308 refines the plan to generate a final trajectory, which is sent to an autonomous vehicle control module or similarly configured vehicle controller for execution. If a trajectory plan candidate is categorized as not practical, the trajectory planner module 308 may request another plan candidate from the scenario plan selector module 306; the vetting and refinement processes described above are then repeated for the new candidate.

With reference now to the flow chart of FIG. 4, an improved method or control strategy for governing operation of an autonomous vehicle, such as automobile 10 of FIG. 1, is generally described at 400 in accordance with aspects of the present disclosure. Some or all of the operations illustrated in FIG. 4 and described in further detail below may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks may be changed, additional blocks may be added, and some of the blocks described may be modified, combined, or eliminated.

Method 400 begins at terminal block 401 with processor-executable instructions for a programmable controller or control module to call up an initialization procedure for a protocol to control an automated driving operation of a motor vehicle. At process block 403, the method 400 provides processor-executable instructions for a system component to determine HV state data, maplet data, path plan data, and dynamic information, all of which are described in detail above in the discussions of FIGS. 2 and 3. At process block 405, a current host vehicle state is determined, in whole or in part, from the data that is collected or created at block 403. The method 400 of FIG. 4 continues on to process block 407 with instructions to track the host vehicle 10 while on route, handle a current scenario for the host vehicle 10 at process block 409, and estimate a search space (execute a search space estimation procedure) at process block 411. As indicated by reference character 302 in FIG. 4, process operations 405, 407, 409 and 411 may be carried out by the scenario processor 302 of cloud computing system 24. In this regard, process block 411 may further require the scenario processor 302 exchange data with the reference path generator processor 304.

Continuing with the discussion of the representative method 400 of FIG. 4, process block 413 includes machine-readable, processor-executable instructions to cache high-resolution, multi-lane boundary information and maneuver information for the planned route. Process block 415 will utilize the cached data, search space estimations, scenario handling approximations, etc., to generate a list of reference plan candidates for a desired vehicle path plan. As described above, a travel cost is calculated and assigned to each reference plan candidate at process block 417, and the listed candidates are then ranked based, at least in part, on the calculated costs at process block 419. As indicated by reference character 304 in FIG. 4, process operations 413, 415, 417 and 419 may be carried out by the reference path generator processor 304 of cloud computing system 24. In this regard, process block 419 may further require the reference path generator processor 304 exchange data with the scenario plan selector module 306 resident to the vehicle 10.

Method 400 continues to process block 421 with processor-executable instructions for a programmable controller or control module to aggregate and process local sensing data and behavioral inputs of the autonomous vehicle 10. Using this information, the method 400 will update the navigation plan cost map at process block 423, and identify an optimal trajectory candidate at process block 425. As indicated by reference character 306 in FIG. 4, process operations 421, 423 and 425 may be carried out by the scenario plan selector module 306 of the vehicle 10. In this regard, process block 425 may further require the scenario plan selector module 306 exchange data with the real-time trajectory planner module 308 resident to the vehicle 10.

With continuing reference to FIG. 4, the method 400 continue to process block 427 to check the practicability of the optimal trajectory candidate identified at process block 425. At decision block 429, the method 400 determines whether or not the optimal trajectory candidate is deemed practical. If the method 400 concludes that a particular candidate is not practical (Block 429=NO), the method 400 proceeds to process block 431 with the transmission of a request to the scenario plan selector module 306 to transmit another candidate. The method 400 automatically responds, at process block 433, by selecting and transmitting the next-in-line optimal trajectory candidate. This new candidate is then evaluated for its practicality at blocks 427 and 429. Once the method 400 finds a candidate that is practical (Block 429=YES), the method 400 proceeds to process block 435 to refine the practical trajectory candidate and thereby establish a final trajectory; the final trajectory is transmitted to and executed by a resident vehicle controller or dedicated control module at 437. The method 400 may then terminate at terminal block 439 and/or loop back to terminal block 401. As indicated by reference character 308 in FIG. 4, process operations 427, 429, 431, 435 and 437 may be carried out by the trajectory planner module 308 of the vehicle 10.

Aspects of this disclosure may be implemented, in some embodiments, through a computer-executable program of instructions, such as program modules, generally referred to as software applications or application programs executed by an onboard vehicle computer or a distributed network of resident and remote computing devices. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in an available manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method for controlling an automated driving operation of a motor vehicle, the method comprising:
determining vehicle state data and path plan data for the motor vehicle, the vehicle state data including a current position and velocity of the motor vehicle, and the path plan data including an origin and desired destination of the motor vehicle;
generating, via a remote computing node off-board from the motor vehicle, a list of trajectory plan candidates based on the vehicle state data, the path plan data, and current road scenario data including real-time contextual data of the motor vehicle;
calculating, via the remote computing node, a respective travel cost for each trajectory plan candidate in the list of trajectory plan candidates;
sorting, via the remote computing node, the list of trajectory plan candidates from a lowest respective travel cost to a highest respective travel cost;
transmitting, from the remote computing node to a resident vehicle controller onboard the motor vehicle, the sorted list of trajectory plan candidates;
identifying, via the resident vehicle controller, the trajectory plan candidate with the lowest respective travel cost; and
executing, via the resident vehicle controller, the automated driving operation based on the identified trajectory plan candidate.

2. The method of claim 1, further comprising estimating, via the remote computing node, a scenario plan for the origin and desired destination of the motor vehicle, the scenario plan including lane centering estimation, lane changing estimation, vehicle passing estimation, and object avoidance estimation, wherein generating the list of trajectory plan candidates is further based on the estimated scenario plan.

3. The method of claim 2, wherein estimating the scenario plan includes handling: expected traffic signs, expected intersections, expected road conditions, expected vehicle maneuvers, and expected traffic conditions.

4. The method of claim 3, further comprising tracking, via the remote computing node, a current route of the motor vehicle.

5. The method of claim 1, further comprising caching, via the remote computing node in a remote memory device, multi-lane boundary and maneuver information for a planned route, wherein generating the list of trajectory plan candidates is further based on the cached multi-lane boundary and maneuver information.

6. The method of claim 1, wherein the resident vehicle controller includes a scenario selector module and a real-time trajectory planner module, the method further comprising:
transmitting, from the remote computing node to the scenario selector module, the respective travel costs for the sorted list of trajectory plan candidates;
determining, via the resident vehicle controller, dynamic vehicle data including data on sensed objects external to the motor vehicle and behavioral preferences of the motor vehicle; and
updating, via the scenario selector module, the respective travel costs for the trajectory plan candidates based on the dynamic vehicle data.

7. The method of claim 6, further comprising re-sorting, via the scenario selector module, the sorted list of trajectory plan candidates from an updated highest respective travel cost to an updated lowest respective travel cost based on the updated respective travel costs.

8. The method of claim 7, further comprising transmitting, from the scenario selector module to the real-time trajectory planner module, an updated trajectory plan candidate with the updated lowest respective travel cost, wherein the automated driving operation executed via the resident vehicle controller is based on the updated trajectory plan candidate.

9. The method of claim 8, further comprising determining if the updated trajectory plan candidate is an optimal candidate including estimating if the updated trajectory plan candidate is collision free and kinodynamically feasible, wherein transmitting the updated trajectory plan candidate from the scenario selector module to the real-time trajectory planner module is responsive to a determination that the updated trajectory plan candidate is the optimal candidate.

10. The method of claim 9, further comprising, in response to a determination that the updated trajectory plan candidate is not the optimal candidate, transmitting a request, from the real-time trajectory planner module to the scenario selector module, for the updated trajectory plan candidate with the updated second lowest respective travel cost.

11. The method of claim 10, further comprising determining, via the real-time trajectory planner module, a final trajectory by refining the updated trajectory plan candidate that is the optimal candidate, wherein the automated driving operation executed via the resident vehicle controller is based on the final trajectory.

12. The method of claim 1, further comprising conducting, via a scenario processor of the remote computing node, a state estimation search including obtaining locally fused lane information and obtaining a semantic road scenario.

13. The method of claim 1, further comprising determining, via a reference path generator processor of the remote computing node, one or more alternative recovery plans.

14. The method of claim 13, further comprising determining dynamic vehicle data and maplet data, the dynamic vehicle data including data on sensed objects external to the motor vehicle and behavioral preferences of the motor vehicle, the maplet data including geographic information for the origin and desired destination of the motor vehicle, wherein generating the list of trajectory plan candidates is further based on the dynamic vehicle data and maplet data.

15. An autonomous vehicle control system comprising:
a motor vehicle with a vehicle body and a resident vehicle controller mounted to the vehicle body, the resident vehicle controller including a scenario selector module and a real-time trajectory planner module; and
a remote computing node off-board from the motor vehicle and including a scenario processor and a reference path generator processor, the remote computing node being configured to:
determine, via the scenario processor, vehicle state data and path plan data for the motor vehicle, the vehicle state data including a current position and velocity of the motor vehicle, and the path plan data including an origin and desired destination of the motor vehicle;
generate, via the reference path generator processor, a list of trajectory plan candidates based on the vehicle state data, the path plan data, and current road scenario data including real-time contextual data of the motor vehicle;
calculate, via the reference path generator processor, a respective travel cost for each trajectory plan candidate in the list of trajectory plan candidates;
sort, via the reference path generator processor, the list of trajectory plan candidates from a lowest to a highest respective travel cost; and
transmit, to the resident vehicle controller of the motor vehicle, the sorted list of trajectory plan candidates,
wherein the resident vehicle controller is configured to:
identify, via the scenario selector module from the sorted list of trajectory plan candidates, the trajectory plan candidate with the lowest respective travel cost; and
execute, via the real-time trajectory planner module, an automated driving operation based on the identified trajectory plan candidate.

16. The autonomous vehicle control system of claim 15, wherein the remote computing node is further configured to estimate, via the scenario processor, a scenario plan for the origin and desired destination of the motor vehicle, the scenario plan including lane centering estimation, lane changing estimation, vehicle passing estimation, and object avoidance estimation, wherein generating the list of trajectory plan candidates is further based on the estimated scenario plan.

17. The autonomous vehicle control system of claim 15, wherein the remote computing node is further configured to cache, via the reference path generator processor, multi-lane boundary and maneuver information for a planned route, wherein generating the list of trajectory plan candidates is further based on the cached multi-lane boundary and maneuver information.

18. The autonomous vehicle control system of claim 15, wherein the resident vehicle controller is further configured to:
receive, from the remote computing node via the scenario selector module, the respective travel costs for the trajectory plan candidates;
determine, via the scenario selector module, dynamic vehicle data including locally sensed objects data and behavioral preferences data of the motor vehicle; and
update, via the scenario selector module, the respective travel costs for the trajectory plan candidates based on the dynamic vehicle data

19. The autonomous vehicle control system of claim 18, wherein the resident vehicle controller is further configured to:
re-sort, via the scenario selector module, the sorted list of trajectory plan candidates from an updated highest respective travel cost to an updated lowest respective travel cost based on the updated respective travel costs; and
transmit, from the scenario selector module to the real-time trajectory planner module, an updated trajectory plan candidate with the updated lowest respective travel cost,
wherein the automated driving operation executed via the resident vehicle controller is based on the updated trajectory plan candidate

20. The autonomous vehicle control system of claim 19, wherein the resident vehicle controller is further configured to:
determine if the updated trajectory plan candidate is an optimal candidate including estimating if the updated trajectory plan candidate is collision free and kinodynamically feasible;
transmitting the updated trajectory plan candidate from the scenario selector module to the real-time trajectory planner module in response to a determination that the updated trajectory plan candidate is the optimal candidate; and
transmit, via the real-time trajectory planner module to the scenario selector module in response to a determination that the updated trajectory plan candidate is not the optimal candidate, a request for the updated trajectory plan candidate with the updated second lowest respective travel cost.
